(19) United States
(12) Patent Application Publication
(10) Pub. No.: US 2012/0177561 A1
(43) Pub. Date: Jul. 12, 2012

(54) NANOSTRUCTURES AND METHODS FOR CHEMICALLY SYNTHESIZING NANOSTRUCTURES

(75) Inventors: Lawrence T. Scott, Newton, MA (US); Eric H. Fort, Boston, MA (US)

(73) Assignee: Trustees of Boston College, Chestnut Hill, MA (US)

(21) Appl. No.: 13/379,167

(22) PCT Filed: Jun. 18, 2010
(86) PCT No.: PCT/US10/01770

§ 371 Date: Mar. 5, 2012

Related U.S. Application Data
(60) Provisional application No. 61/220,835, filed on Jun. 26, 2009.
(60) Provisional application No. 61/226,211, filed on Jul. 16, 2009.

(51) Int. Cl. D01F 9/12; C01B 31/00; C01B 31/02; C01B 31/04; B82Y 30/00; B82Y 40/00

(52) U.S. Cl. 423/447.1; 423/445 R; 423/448; 977/842; 977/742; 977/734

(57) ABSTRACT

The present invention generally relates to nanostructure compositions, as well as methods for the controlled synthesis of nanostructures, such as carbon nanotubes. In some embodiments, methods involving iterative growth of a nanostructure template to homogeneously produce nanostructure compositions are provided. The compositions may include nanostructures having a specific length, width, diameter, ring orientation, and/or other characteristics. Using methods described herein, nanostructures (e.g., nanotubes) having uniform properties, such as electrical conductivity, may be readily produced. The ability to provide homogeneous nanostructure compositions may be advantageous in the design and fabrication of numerous materials and electronic devices.

### FIELD OF THE INVENTION

The present invention generally relates to nanostructures and methods for the synthesis of nanostructures, such as carbon nanotubes.

### BACKGROUND OF THE INVENTION

Carbon nanotubes can lay the groundwork for the next generation of electronics and materials. Their mechanical and electrical properties are predicted to surpass those achievable by current technologies. Current methods for producing carbon nanotubes include graphite arc discharge, chemical vapor deposition, HiPco, laser ablation transition metal catalysts to seed nanotube growth. Many current methods require great amounts of energy and resources, yet rely on empirical procedures that typically result in complex mixtures of nanotubes with varying diameter, chirality, length, and electronic properties. For example, some nanotube production methods result in mixtures of single-walled (SWNT), multi-walled (MWNT), chiral, and achiral nanotubes of varying lengths and diameters. Additionally, methods for isolating one particular variety of nanotube from such mixtures can be highly inefficient and have been demonstrated only on small scales, often relying on complexation with larger molecules, including DNA, or chemical modification of the nanotube structure. The inaccessibility of homogeneous samples of uniform carbon nanotubes has often hindered development of technologies that require just one type of pure nanotube.

### SUMMARY OF THE INVENTION

The present invention relates to compositions comprising a plurality of nanostructures, wherein at least 50% of the nanostructures have essentially the same diameter and/or ring orientation, or exhibit essentially the same electrochemical properties when placed under essentially the same set of conditions.

The present invention also provides various methods for synthesizing nanostructures. In some embodiments, the method comprises reacting a nanostructure precursor comprising a fused network of aromatic rings and a border at which the fused network terminates with a dienophile via a cycloaddition reaction to form a ring fused to the border of the nanostructure precursor.

In some embodiments, the method comprises reacting a nanostructure precursor comprising a fused network of aromatic rings and a border at which the fused network terminates with a dienophile via a cycloaddition reaction to form a nanostructure product, wherein at least 50% of the nanostructure product comprises nanostructures have essentially identical length, diameter, and/or ring orientation.

### BRIEF DESCRIPTION OF THE DRAWINGS

FIG. 1 shows examples of various templates for (a) unidirectional growth of a single chirality carbon nanotube, (b) bidirectional growth of a single chirality carbon nanotube, and (c) growth of a graphene sheet, wherein arrows depict direction of growth.

FIG. 2 shows a graph of transition state energy for the Diels-Alder cycloaddition of acetylene to various polycyclic aromatic hydrocarbons (PAHs).

FIG. 3 shows methods of growth with (a) a diene and dienophile, (b) a polycyclic aromatic template and a dienophile, reaction between a substituted bisanthene and (c) phenylvinyl sulfoxide, (d) ortho-phenyldiazonium carboxylate, (e) nitroethylene, (f) 2-(trimethylsilyl) phenyl triflate and TBAF, and (g) acetylene.

FIG. 4 shows crystal structures of a substituted bisanthene before (left) and after (right) formation of two new fused, aromatic rings.

FIG. 5 shows examples of different types of nanotubes and their corresponding nanotube end-caps.

FIG. 6 illustrates examples of bay regions at the border of a nanostructure precursor, including (a) a portion including one bay region, (b) multiple portions each including one bay region, and (c) a portion including multiple bay regions.

FIG. 7 illustrates the synthesis of a [5,5]nanotube, according to one embodiment of the invention.

FIG. 8 shows the synthesis of (a) 1,3,5,7,9-pentakis(o-chlorophenyl) corannulene and (b) pentaindenocorannulene.

FIG. 9 shows the synthesis of (a) 1,3,5,7,9-pentakis(2,6-dichlorophenyl) corannulene and (b) a C₅₀H₁₀ nanotube end-cap, and (c) high resolution mass spectrum and (d) ¹H NMR spectrum of the C₅₀H₁₀ nanotube end-cap.

FIG. 10 shows a proposed synthesis of (a) a C3v C₆₀H₁₂ [6,6]SWNT end-cap, (b) C3v C₆₆H₁₂ [6,6]SWNT end-cap, and (c) a C5v C₁₂₀H₂₀ [10,10]SWNT end-cap.

Other aspects, embodiments and features of the invention will become apparent from the following detailed description when considered in conjunction with the accompanying drawings. The accompanying figures are schematic and are not intended to be drawn to scale. For purposes of clarity, not every component is labeled in every figure, nor is every component of each embodiment of the invention shown where illustration is not necessary to allow those of ordinary skill in the art to understand the invention. All patent applications and patents incorporated herein by reference are incorporated by reference in their entirety. In case of conflict, the present specification, including definitions, will control.

### DETAILED DESCRIPTION

The present invention generally relates to nanostructure compositions, as well as methods for the controlled synthesis of nanostructures, such as carbon nanotubes. Using methods described herein, nanostructures (e.g., nanotubes) having desirable properties, such as electrical conductivity, can be readily produced.

Some embodiments of the invention may involve iterative growth of a nanostructure template to homogeneously produce nanostructure compositions, where the majority of nanostructures formed may have a specific length, width, diameter, ring orientation, and/or other characteristics, rather than producing a mixture of nanostructures. The ability to provide homogeneous nanostructure compositions may be advantageous in the design and fabrication of numerous materials and electronic devices, where nanostructure having uniform properties, such as uniform conductive properties, may significantly enhance device performance. Additionally, methods of the invention may be performed under mild conditions (e.g., low temperatures), relative to previous methods, and may be performed in solution, rather than in the gas phase. The methods may also be performed without need for catalysts or complex purification procedures. Furthermore, materials (e.g., feedstocks) utilized for the production of nanostructures are readily available and relatively low in cost.

In some embodiments, nanostructure compositions are provided. The composition may primarily include a single type of nanostructure, rather than a mixture of nanostructures. That is, at least 50% of a plurality of nanostructures may have essentially the same diameter and/or ring orientation, or may exhibit essentially the same electrochemical properties when placed under essentially the same set of conditions. In one set of embodiments, the nanostructure may be a nanotube, such as a single-walled nanotube or a multi-walled nanotube. For example, the composition may include carbon nanotubes, where a majority of the nanotubes are of a single type of nanotube (e.g., armchair, zig-zag, or a particular chiral nanotube). In some embodiments, at least 50% of the plurality of nanostructures may be armchair nanotubes. The composition may, in some cases, include primarily a single type of nanostructure in the absence of any separation or purifications steps (e.g., chromatography, crystallization, etc.).

As used herein, a “plurality of nanostructures” refers to a random collection of nanostructures from a sample of the composition. For example, in a nanotube composition comprising at least 50% armchair nanotubes relative to the total bulk of the composition, a “plurality of nanostructures” refers to a portion of the composition containing a representative sample of the total, bulk composition, i.e., a portion comprising at least 50% armchair nanotubes. A plurality of nanostructures does not, however, refer to a collection of nanostructures specifically selected from a sample for having similar chemical structure, diameter, ring orientation, electrochemical properties, and/or other properties. For example, in a composition including a mixture of different types of nanotubes (e.g., nanotubes of varying diameter, ring orientation, etc.), where 1% of the mixture comprises armchair nanotubes, a “plurality of nanostructures” does not refer to selected nanotubes within the 1% of the composition that comprises armchair nanotubes. Rather, the plurality of nanostructures refers to a randomly selected portion of the composition that is a representative sample of the total, bulk composition, i.e., a portion comprising 1% armchair nanotubes.

In some embodiments, methods for the synthesis of nanostructures are provided. Methods described herein may generally involve use of a nanostructure template (e.g., precursor), where growth or elongation of the template may produce a particular nanostructure. The nanostructure may be, for example, a nanotube, a nanowire, a sheet of graphene, or the like. In some cases, the method may involve performing a series of chemical reactions in an iterative manner in order to produce a desired nanostructure product. For example, in the synthesis of a nanotube (e.g., carbon nanotube), the method may involve reacting an end-cap of a nanotube with a chemical species to form a new ring of carbon atoms at the border or rim of the end-cap. Repetitive addition of new rings of carbon atoms at the border of the growing nanotube may provide the final nanostructure product. By selection of the appropriate template, nanostructures having specific properties and dimensions may be homogeneously produced, as the template can fix, or “lock in” certain structural characteristics during growth, including length, width, diameter, ring orientation, and/or chirality of the nanostructure.

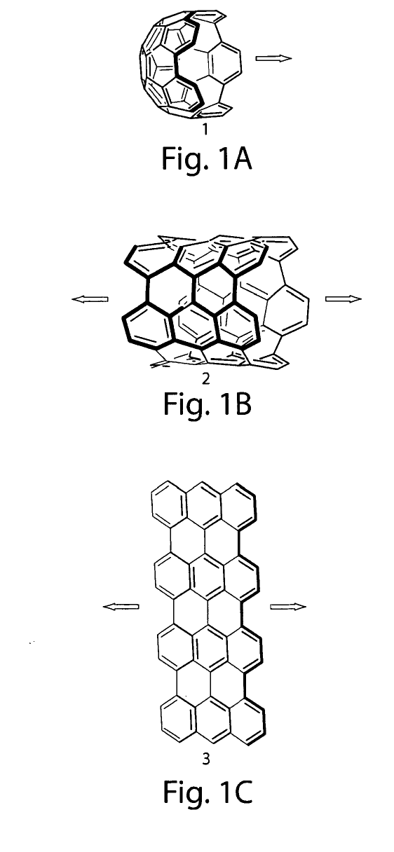

For example, FIG. 1 shows several templates or precursors that may be utilized to form various nanostructures. FIG. 1A shows compound 1, a hemisphere-shaped polycyclic aromatic hydrocarbon including a fused network of unsaturated 5- and 6-membered rings, which can be used as a template for carbon nanotubes. That is, compound 1 can grow unidirectionally to form the walls of a nanotube. Additionally, such methods can provide the ability to convert even small mass quantities of, for example, end-cap templates, into nanotubes of higher mass, since several iterations of growth can add significant length and mass to a molecule. Other suitable templates for nanotube growth include aromatic loops or “belts,” as shown in FIG. 1B, which may provide for growth in two directions simultaneously, and graphene sheets, as shown in FIG. 1C, which may provide for growth or enlargment/elongation of aromatic ribbons. The chemcial structure of the template or precursor may be selected to control nearly every aspect of the growing nanotube (e.g., diameter, ring orientation, etc.), as described more fully below.

In some cases, methods of the invention may involve reacting a nanostructure precursor to form a nanostructure product, wherein at least 50%, at least 60%, at least 70%, at least 80%, at least 90%, at least 95%, at least 99%, or, in some cases, 100% of the nanostructures formed have essentially the same nanotube diameter. That is, the nanostructures may be formed in a homogeneous manner, prior to, or without need for, a purification or isolation step to remove other types of undesired nanostructures. As used herein, a nanostructure having “essentially the same” property (e.g., diameter, ring orientation, electrochemical property) as another nanostructure means that a property of a first nanostructure differs from that of a second, adjacent nanostructure by less than 10%, less than 5%, or, in some cases less than 1%, when measured under essentially identical conditions. Nanotube diameter may be measured by various microscopy methods known in the art.

In some embodiments, at least 50%, at least 60%, at least 70%, at least 80%, at least 90%, at least 95%, at least 99%, or, in some cases, 100% of the nanostructures formed may have essentially the same nanostructure length, width, and/or other structural dimension. For example, where nanotubes are formed, at least 50% of the nanotubes formed may have essentially the same nanotube length. As used herein, nanotube length may be determined by measuring the distance between ends of the nanotube along the long axis of the nanotube. The length of nanostructures may be measured by various microscopy methods known in the art.

In some cases, nanotubes may be formed, wherein at least 50%, at least 60%, at least 70%, at least 80%, at least 90%, at least 95%, at least 99%, or, in some cases, 100% of the nanotubes formed may have essentially the same nanotube ring orientation. As used herein, the term “nanotube ring orientation” is given its ordinary meaning in the art and refers to the orientation of a six-membered ring in the nanotube lattice relative to the long axis of the nanotube. Examples of nanotubes having different ring orientations include armchair nanotubes, zig-zag nanotubes, and chiral nanotubes. Those of ordinary skill in the art would understand the meaning of these terms. In some embodiments, single chirality nanotubes may be synthesized using methods described herein.

In some cases, at least 50%, at least 60%, at least 70%, at least 80%, at least 90%, at least 95%, or, in some cases, at least 99%, or, in some cases, 100% of a plurality of nanostructures may exhibit essentially the same electrochemical properties when placed under essentially the same set of conditions. For example, a majority of the nanostructures may exhibit a particular desired electrochemical property, including conductivity, metallic properties, semiconductor properties, or the like. In one set of embodiments, at least 99% of the nanostructures may be conductive, armchair nanotubes.

As described herein, a desired nanostructure may be produced by elongation or growth of an appropriate nanostructure precursor. In some cases, the nanostructure precursor may comprise a fused network of unsaturated rings, and growth may be achieved by appending new features or portions (e.g., rings) to the border or perimeter of the nanostructure precursor in an iterative fashion. The nanostructure precursor may be, for example, elongated such that its molecular weight is increased. Such elongation or growth may be achieved by the addition of various carbon-containing moieties to the nanostructure precursor. The length of the nanostructure precursor can be increased in one direction, in two directions, or more.

In some embodiments, a new ring can be formed at the perimeter of the nanostructure material, i.e., a new ring fused to the border of the nanostructure precursor may be formed. That is, at least two ring atoms of the newly formed ring may be atoms of the border of the nanostructure precursor. The newly formed ring may be, for example, a substituted or an unsubstituted benzene ring. In some cases, a new ring may be formed via a pericyclic reaction, such as a cycloaddition reaction (e.g., Diels-Alder reaction, 1,3-dipolar cycloaddition, etc.). For example, a nanostructure precursor and a chemical species may react via a cycloaddition reaction to form a new ring fused to the border of the nanostructure precursor. The cycloaddition reaction may then be repeated until the desired nanostructure product is formed. For example, cycloaddition reactions may be performed on a nanotube precursor to increase the length of the nanostructure precursor, until a nanotube having a particular desired length is produced.

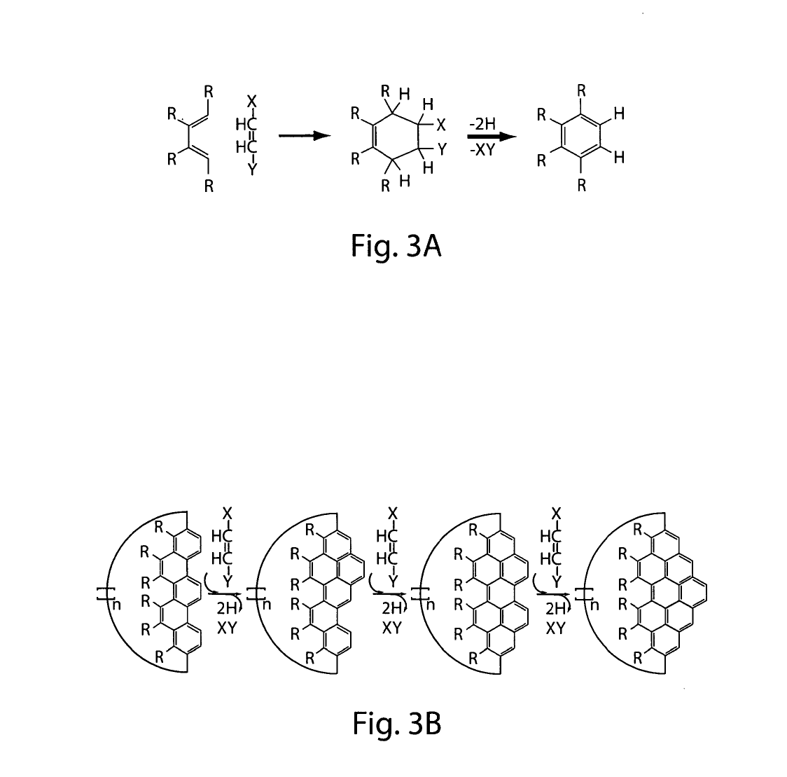

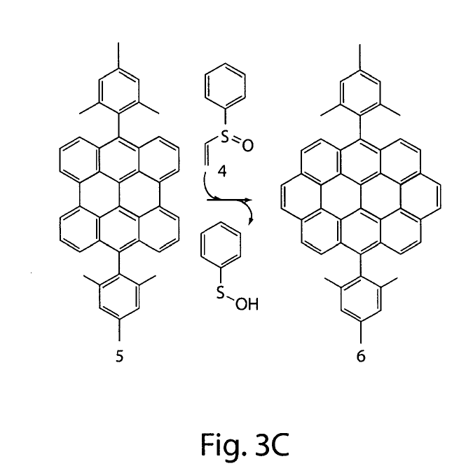

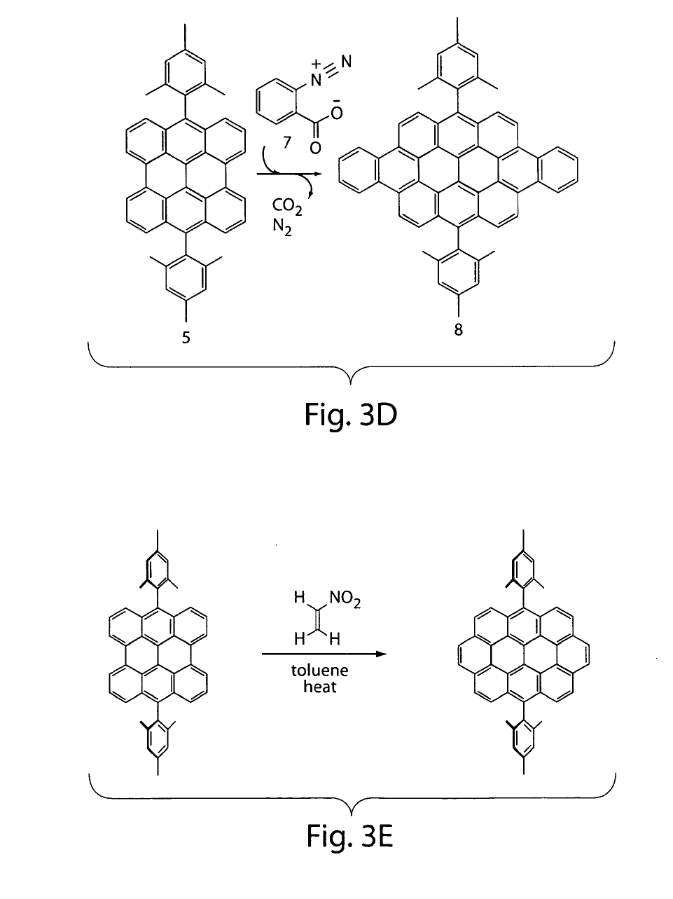

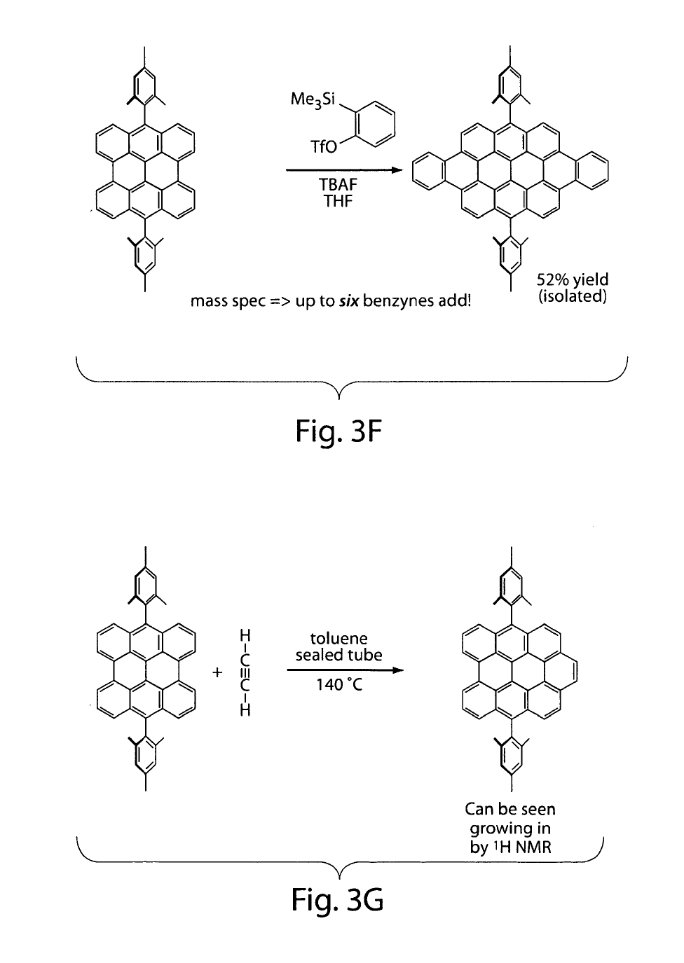

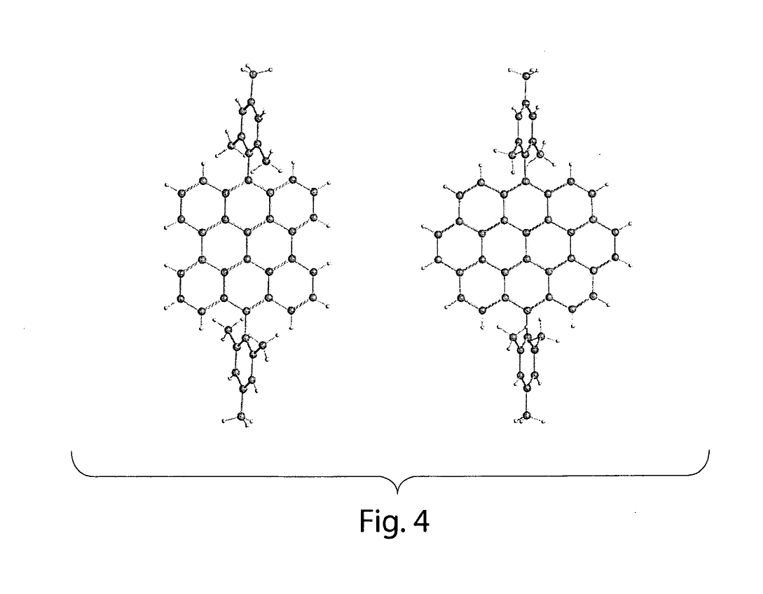

In some cases, upon reaction with a dienophile, the newly formed ring (e.g., fused to the border of the nanostructure precursor) may be a non-aromatic ring. Aromaticity of the ring may then be established upon disassociation of at least one atom or group of atoms (e.g., thermal loss, oxidative loss, etc.). The disassociation may comprise thermal loss of hydrogen, an intramolecular elimination reaction, cyclodehydrogenation reaction, or other reaction resulting in the loss of an atom or group of atoms and establishment of aromaticity. FIGS. 3A-3G show some examples of a cycloaddition reaction between a nanostructure precursor and various dienophiles, followed by a disassociation/aromatization step.

In one set of embodiments, the method involves reacting a nanostructure precursor and a dienophile via a Diels-Alder to form a new, non-aromatic ring fused to the border of the nanostructure precursor. Subsequent, spontaneous aromatization of the new ring may regenerate a species capable of continued cycloaddition. That is, upon regeneration of aromaticity, the border of the nanostructure precursor may be further reacted via another Diels-Alder reaction. In the illustrative embodiment shown in FIG. 3B, the method involves (1) a Diels-Alder cycloaddition to form each new 6-membered ring, (2) thermodynamically-driven loss of the original bay region hydrogens to rearomatize the rings in which cyclic conjugation was temporarily disrupted, and (3) thermal loss of additional substituents (e.g., X and Y) from the newly appended 2-carbon bridge to aromatize the new ring. Any of the reactions described herein can be conducted under relatively mild conditions. In some embodiments, the reaction may be performed by combining the nanostructure precursor and dienophile in solution.

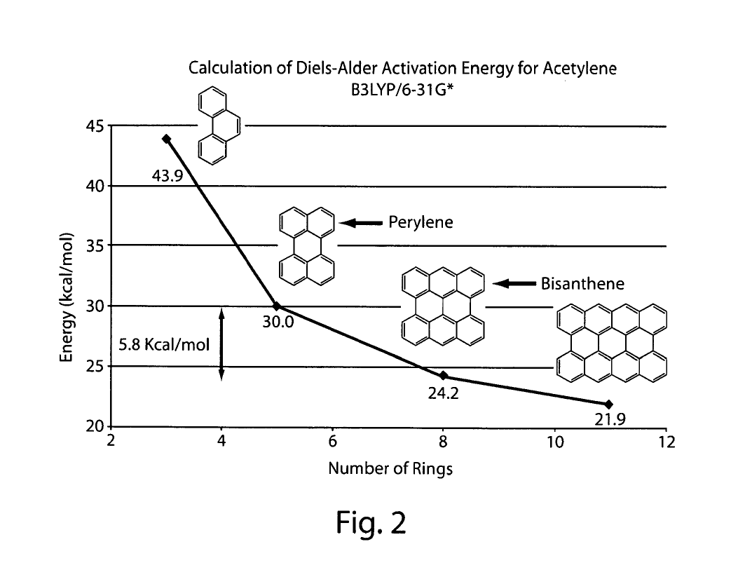

The nanostructure precursor may be any species comprising at least one reaction site to which a ring (e.g., a carbon ring) may be appended or fused via a chemical reaction. In some cases, the nanostructure precursor may be selected to have reaction site(s) capable of participating in a cycloaddition reaction. For example, the reaction site may be a diene capable of forming a ring with a dienophile via a Diels-Alder reaction. In some cases, the nanostructure precursor may be selected to have a sufficiently low activation energy to undergo a cycloaddition reaction, which generally involves interruption of the aromaticity of the fused network of aromatic rings, with the dienophile. In some embodiments, the nanostructure precursor may be selected to have a cycloaddition activation energy of less than 30 kcal/mol, less than 25 kcal/mol, or less than 22 kcal/mol. It should be understood, however, that nanostructure precursors having other cycloaddition activation energies (e.g., greater than 30 kcal/mol) may also be used in the context of the invention. Those of ordinary skill in the art would be able to select the appropriate combination of nanostructure precursor and dienophile for use in a cycloaddition reaction, as described herein. The activation energies described herein may be calculated using B3LYP/6-31G* density functional theory. As used herein, the term “activation energy” is given its ordinary meaning in the art and refers to the minimum amount of energy that is needed in order for a chemical reaction to occur. FIG. 2 shows examples of calculated activated energies for various polycyclic aromatic hydrocarbons that may be useful as nanostructure precursors.

Without wishing to be bound by theory, the activation energy for a nanostructure precursor to undergo a cycloaddition reaction with a particular dienophile may be overcome by providing a nanostructure precursor with a sufficiently large aromatic network which can absorb the energetic cost of interrupting aromaticity. For example, a cycloaddition between a phenanthrene molecule, having an activation energy of 43.9 kcal/mol, and a dienophile such as acetylene may not readily occur using known methods. However, a cycloaddition between a bisanthene molecule, having an activation energy of 24.2 kcal/mol, and a dienophile such as acetylene may readily occur using methods described herein. Selection of an appropriate nanostructure precursor and dienophile may allow for cycloaddition reactions to occur at the border of the nanostructure precursor. In one set of embodiments, the dienophile may be acetylene, and the nanostructure precursor may be selected to have a cycloaddition activation energy of less than 30 kcal/mol.

Typically, the nanostructure precursor may include at least a portion of a nanostructure, such as a nanotube end-cap or a portion of a graphene sheet. The nanostructure precursor may be substantially planar or substantially non-planar, or may comprise a planar or non-planar portion. Generally, the nanostructure precursor comprises a fused network of aromatic rings, wherein the network includes a border or perimeter at which the fused network terminates. The network may include, for example, six-membered rings and/or five-membered rings, as well as other types of rings, fused together and arranged in various configurations. As used herein, the term “fused network” might not include, for example, a biphenyl group, wherein two phenyl rings are joined by a single bond and are not fused. In some cases, the fused network may substantially comprise carbon atoms. In some cases, the fused network may comprise carbon atoms and heteroatoms.

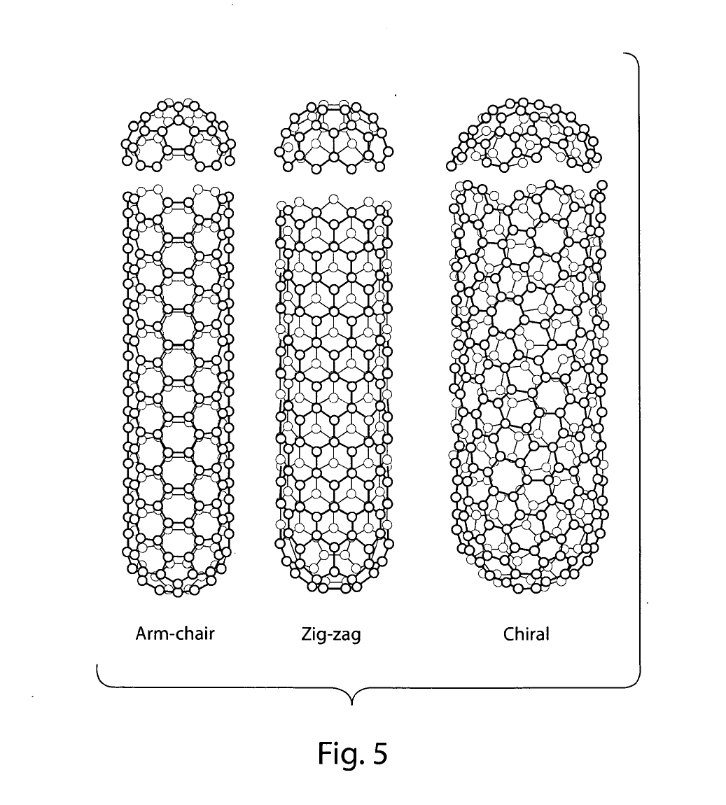

Depending on the arrangement of rings in the fused network, the border or perimeter of the nanostructure precursor may have various morphologies and/or reactivities. As an illustrative embodiment, FIG. 5 shows various nanotube end-caps, some of which may be useful as nanostructure precursors. For example, the end-caps of armchair and chiral nanotubes each include a different arrangement of rings at the perimeter of the end-cap and may be reacted with a dienophile via a cycloaddition reaction.

The structure of the nanostructure precursor, including the arrangement of rings along the perimeter of the nanostructure precursor, may control the reactivity of the perimeter and may determine the manner in which nanostructure growth occurs. In some embodiments, “bay regions” along the border of a nanostructure precursor may provide reactive sites for formation of a newly appended ring. The term “bay region” is given its ordinary meaning in the art and refers to portions of a polycyclic aromatic molecule which are analogous to the portion defined by the four carbon atoms positioned between, and including, the 4-position and 5-position of a phenanthrene molecule. For example, as shown in FIG. 3B, the dienophile moiety reacts with the bay region of the polycyclic aromatic hydrocarbon.

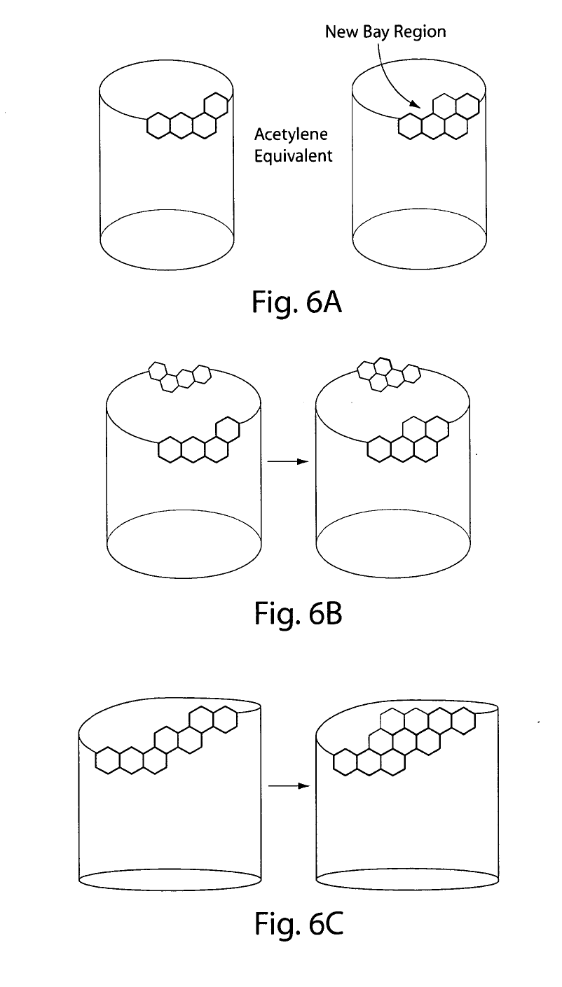

In some cases, the method may involve formation of a new bay region at the nanostructure precursor border, upon reaction with a dienophile. FIG. 6 illustrates examples of bay regions that may be present at the border of a nanostructure precursor and/or new bay regions that may be formed upon reaction with one or more dienophiles. FIG. 6A shows a portion of a nanostructure precursor border comprising one bay region and, upon reaction with a dienophile, formation of a new bay region that is available for further reaction with another dienophile. Similar reactions may take place at multiple locations of the nanostructure precursor border, as shown in FIG. 6B. In some embodiments, the nanostructure precursor may include multiple bay regions at one site along the nanostructure precursor border, as shown in FIG. 6C.

In the synthesis of nanostructures, the selection and design of the nanostructure precursor may allow for controlled growth of the resulting nanostructure. For example, use of the end-cap of an armchair nanotube as the nanostructure precursor can produce a nanostructure product comprising primarily armchair nanotubes, since the reactivity of the armchair end-cap in the presence of a dienophile reduces the occurrence of side reactions and/or formation of undesired byproducts. That is, use of the methods described herein may reduce the formation of a mixture of different types of nanostructure products and may homogeneously produce a particular, desired product. For example, use of an armchair nanostructure precursor (e.g., armchair nanotube end-cap) can substantially prevent formation of zig-zag nanotubes, or other side products.

The nanostructure precursor may optionally comprise a nonplanar portion, e.g., a curved portion having a convex surface and a concave surface (where “surface,” in this context, defines a side of a molecule or sheet defining a polycyclic structure). Examples of species comprising non-planar portions include fullerenes, carbon nanotubes, and fragments thereof, such as corannulene. In some cases, the nonplanar aromatic portion may comprise carbon atoms having a hybridization of sp^{2.x}, wherein x is between 1 and 9, i.e., the carbon atom may have a hybridization between sp²- and sp³-hybridization, where this hybridization is characteristic of non-planarity of the molecule as would be understood by those of ordinary skill in the art. In these embodiments, x can also be between 2 and 8, between 3 and 7, or between 4 and 6. Typically, planar aromatic groups and polycyclic aromatic groups (e.g., phenyl, naphthyl) may comprise carbon atoms having sp² hybridization, while non-aromatic, non-planar groups (e.g., alkyl groups) may comprise carbon atoms having sp³ hybridization. For carbon atoms in a nonplanar aromatic group, such as a nonplanar portion of a carbon-containing molecule, sp²-hybridized carbon atoms may be distorted (e.g., bent) to form the nonplanar or curved portion of the nanostructure precursor.

In some embodiments, polycyclic aromatic hydrocarbons may be used as a nanostructure precursor, where the “bay regions” of the polycyclic aromatic hydrocarbon can be converted into new aromatic six-membered rings via a cycloaddition reaction. As an illustrative embodiment, a bisanthene molecule, which exhibits electronic properties resembling those of armchair carbon nanotubes, may be used as a template for the synthesis of an armchair nanotube. Using methods described herein, formal C₂H₂ or C₆H₄ addition may be performed across the bay regions of bisanthene. FIGS. 3A-3G show various examples of the reaction between a substituted bisanthene molecule and dienophiles.

In some embodiments, a nanotube end-cap may be used as a nanotube precursor. As used herein, the term “end-cap” refers to a portion of a nanotube comprising a hemisphere-shaped end of a nanotube. In some embodiments, the nanotube precursor may be a substituted bisanthene molecule. In some embodiments, the nanotube precursor may be a curved polycyclic aromatic hydrocarbon, such as a subunit of a fullerene molecule (e.g., C₃₆H₁₂ hydrocarbon bowl, C₄₀H₁₄ hydrocarbon bowl, C₅₀H₁₀ hydrocarbon bowl).

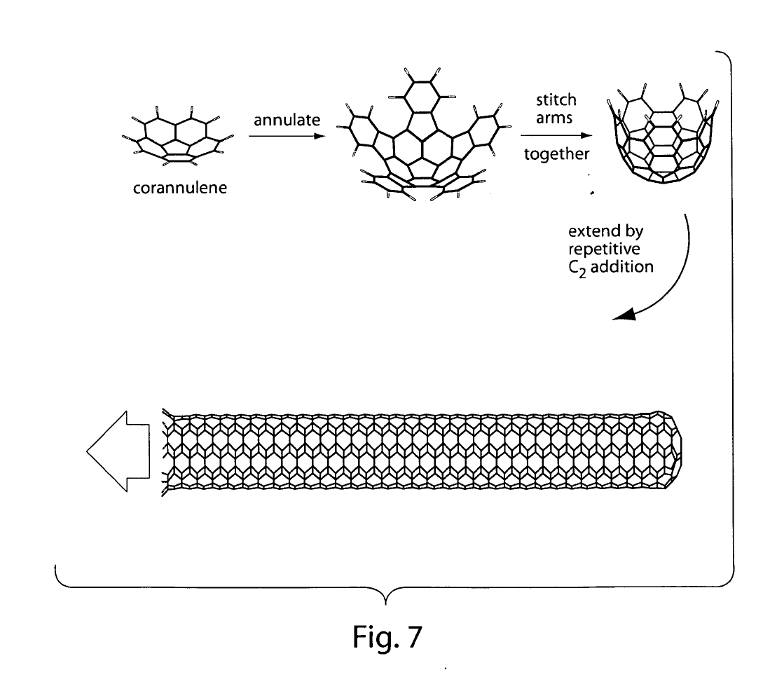

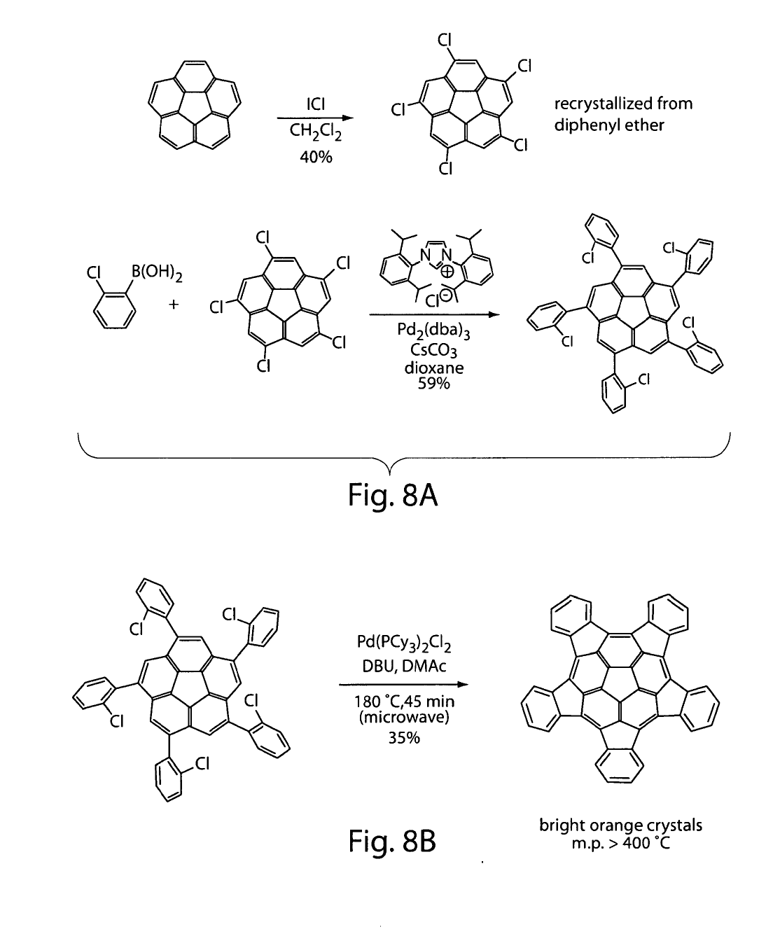

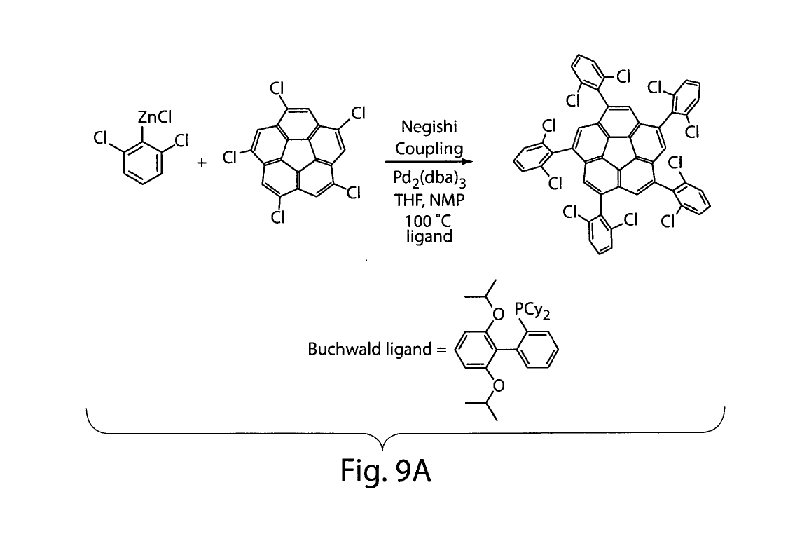

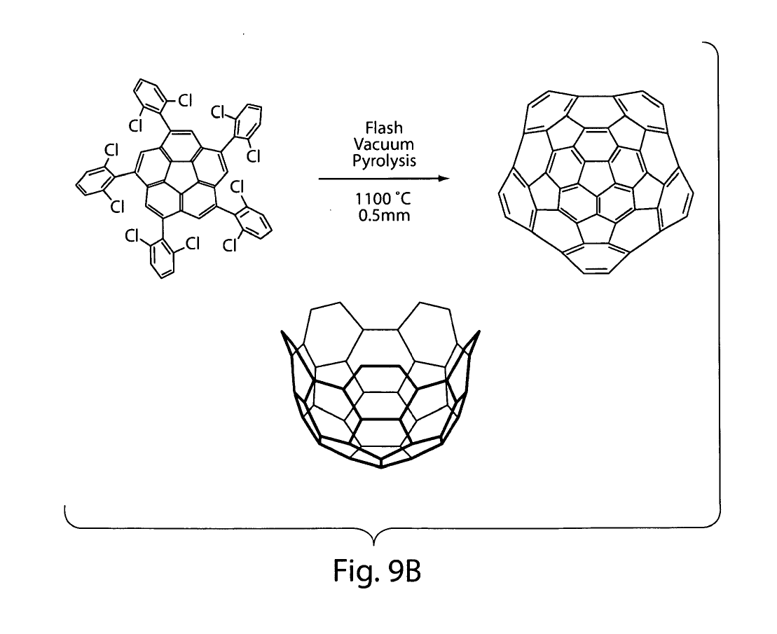

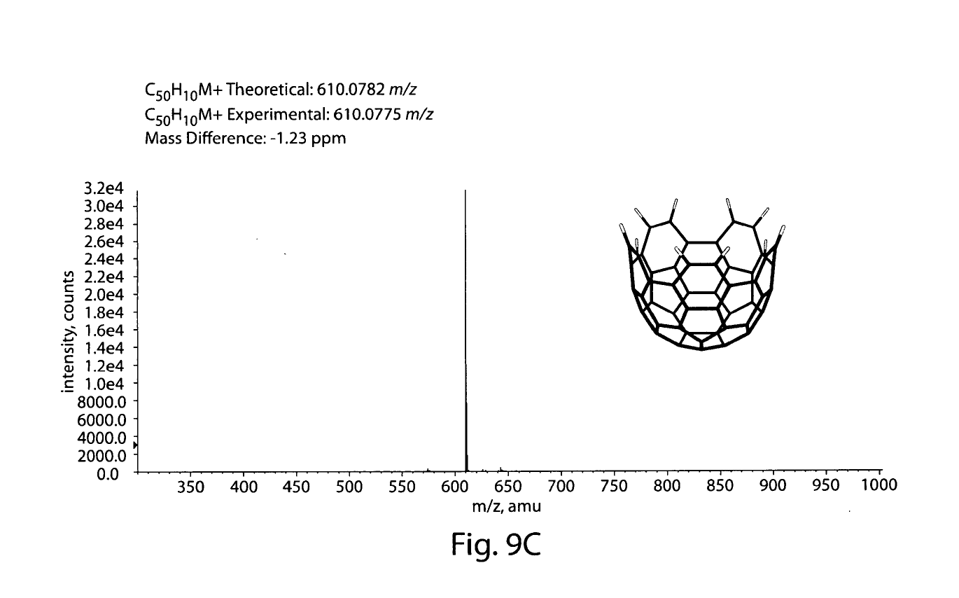

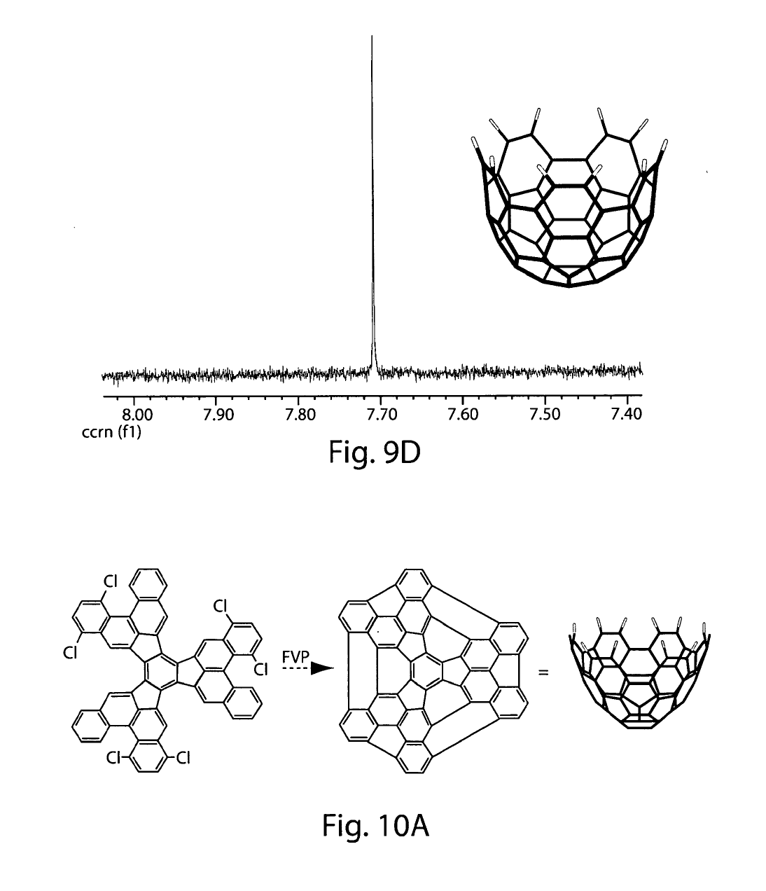

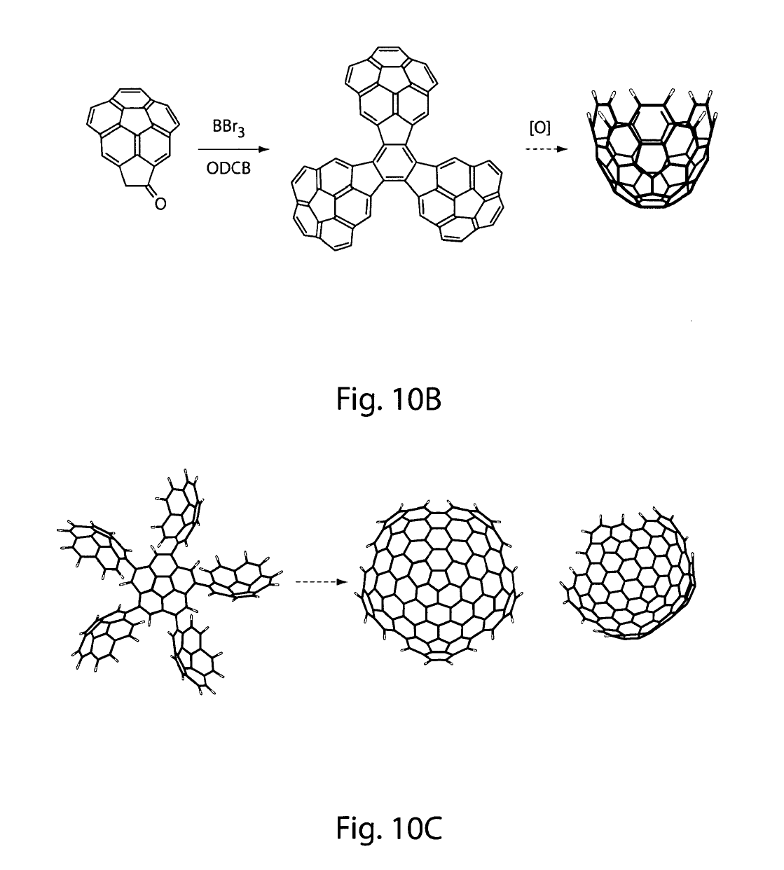

The nanostructure precursor may be synthesized using various methods. In some embodiments, the nanostructure precursor may be a curved polycyclic aromatic hydrocarbon (e.g., nanotube end-cap) synthesized via flash vacuum pyrolysis of a halide-substituted species or transition-metal catalyzed coupling of a halide-substituted species. In one set of embodiments, the nanostructure precursor may be synthesized by modifying and/or expanding a core aryl group, such as a corannulene molecule. As shown in FIG. 7, various groups may be appended to a corannulene molecule to form a nanotube end-cap molecule, which may then be elongated to form a nanotube using methods described herein. In an illustrative embodiment, FIGS. 8A-B shows the synthesis of a pentaindenocorannulene species via a two-step, transition-metal catalyzed process. Similarly, FIGS. 9A-D show the synthesis and characterization of a C₅₀H₁₀ nanotube end-cap via transition-metal catalyzed coupling between corannulene and a dihalide aryl group, followed by flash vacuum pyrolysis. The C₅₀H₁₀ nanotube end-cap may then be elongated by iterative cycloadditions with a dienophile to grow an armchair nanotube. FIG. 10 illustrates additional examples of nanotube precursors, which may be used to produce nanotubes having a specific diameter, ring orientation, and/or electrochemical property.

In some embodiments, the nanostructure precursor may be provided by processing a commercially available nanostructure species to produce a nanostructure precursor substantially free of heteroatoms and/or metal atoms. For example, a nanostructure species may include oxygen species, such as carbonyl groups, and/or metal species at or near the border of the nanostructure species. Conversion of such species into carbon-carbon bonds and/or carbon-hydrogen bonds may provide a nanostructure precursor substantially free of heteroatoms and/or metal atoms, i.e., a hydrocarbon species.

The term “dienophile” or “dipolarophile” is given its ordinary meaning in the art and refers to any species comprising at least one carbon-carbon or carbon-heteroatom double bond or triple bond. For example, the dienophile may include an alkene, heteroalkene, an alkyne, or a heteroalkyne, optionally substituted. In some cases, the dienophile may be substituted with one or more electron withdrawing groups. The term “electron-withdrawing group” is recognized in the art and as used herein means a functionality which draws electrons to itself more than a hydrogen atom would at the same position. Examples of electron-withdrawing groups include CHO, COR, COOH, COCl, CN, NO₂, NO, CH₂OH, CH₂Cl, CH₂NH₂, CH₂CN, CH₂COOH, halogen, sulfoxides, sulfones, or the like.

In some embodiments, the dienophile is acetylene. In some embodiments, the dienophile is a masked acetylene, i.e., a non-acetylene species that may serve as a dienophile in a [4+2] cycloaddition reaction. In some embodiments, the masked acetylene may have the formula,

XHC═CH₂

or

XHC═CHY,

wherein X is an electron-withdrawing group; and Y is an atom or group of atoms that, upon reacting with the nanostructure precursor, is capable of dissociating from the nanostructure product. In some cases, X and/or Y may be a nitro group or a phenylsulfoxide group. As shown in FIGS. 3A-B, the masked acetylene group may undergo a [4+2] cycloaddition reaction with a nanostructure precursor, followed by a dissociation/aromatization step in which an equivalent of hydrogen and “X—Y” are lost.

In some embodiments, the dienophile is acetylene, phenylvinyl sulfoxide, nitroethylene, or a benzyne species. In one embodiment, the dienophile is acetylene. In another embodiment, the dienophile is phenylvinyl sulfoxide. In another embodiment, the dienophile is nitroethylene. The dienophile may, in some cases, be generated in situ. For example, nitroethylene may be generated in situ from 2-nitroethanol, 1-bromo-2-nitroethane, or the like. In some embodiments, the benzyne species may be generated in situ from a benzyne precursor, such as ortho-phenyldiazonium carboxylate or 2-(trimethylsilyl) phenyl triflate. For example, 2-(trimethylsilyl) phenyl triflate may be treated with TBAF in situ to generate a benzyne species capable of serving as a dienophile. Those of skill in the art would be able to select other methods for in situ generation of benzyne species or other dienophiles, for use in the context of the invention.

Other examples of dienophile include species comprising one or more heteroatoms, such that cycloaddition with the nanostructure precursor results in formation of ring including at least one heteroatom ring atom. For example, the dienophile may be boron nitride (e.g., HB≡NH), and cycloaddition with a nanostructure precursor may form a ring including a boron ring atom and a nitrogen ring atom.

Methods described herein may advantageously be performed in solution. That is, the reactants may be combined with a fluid carrier or solvent (e.g., an organic solvent, an aqueous solvent). Solvents which may be used in methods of the invention include benzene, halobenzenes (e.g., bromobenzene, chlorobenzene, ortho-dichlorobenzene, 1,2,4-trichlorobenezene), p-cresol, toluene, xylene, diethyl ether, glycol monomethyl or dimethyl ether, petroleum ether, hexane, cyclohexane, methylene chloride, chloroform, carbon tetrachloride, dioxane, tetrahydrofuran (THF), dimethyl sulfoxide, dimethylformamide, hexamethyl-phosphoric triamide, ethyl acetate, pyridine, triethylamine, picoline, mixtures thereof, or the like. In a particular embodiment, toluene is the preferred solvent.

As noted above, an advantageous feature of the invention is the ability to produce a homogenous nanostructure product, where purification or separation steps may not be required to separate the desired nanostructure product from undesired side products, including undesired nanostructure products. That is, the methods may produce nanostructures that are substantially homogenous in diameter, orientation, and/or properties, such as electronic properties (e.g., conductivity).

Methods of the invention may advantageously be performed using relatively mild conditions, compared to known methods, to form nanostructures as described herein. For example, the reaction may be performed at temperatures less than 1000° C., less than 800° C., less than 600° C., less than 500° C., less than 400° C., less than 300° C., less than 200° C., less than 150° C., less than 100° C., or, in some cases, less than 50° C. In some embodiments, the reaction may be performed at about room temperature. Additionally, methods described herein may be performed in the absence of a catalyst, i.e., a metal catalyst. In some embodiments, this may advantageously produce nanostructures which are substantially free of metal atoms, for example, at the border of the fused network or aromatic rings.

In another set of embodiments, methods described herein may be useful in the separation of different types of nanostructures. For example, a mixture of nanotubes may include armchair, zig-zag, and/or various chiral nanotubes. The mixture may be treated such that the borders of the nanotubes are converted to hydrocarbon species capable of undergoing cycloadditions as described herein. The mixture may then be exposed to a dienophile, where elongation of the nanotubes may take place for some nanotubes to a greater degree than others, depending on the type of nanotube and structure of the nanotube border. For example, nanotubes which lack bay regions at the border may undergo cycloaddition reactions with a dienophile to a lesser degree, or not at all, relative to those which include bay regions at the border. In some embodiments, a mixture of nanotubes may be exposed to a dienophile, wherein nanotubes comprising a rim not capable of undergoing sustained growth/elongation (e.g., zig-zag nanotubes, as well as chiral nanotubes having or forming at least one cove region) that may be present are substantially unreactive to the dienophile and do not undergo elongation. Elongated nanotubes may then be readily separated from the nanotubes which did not undergo elongation.

As used herein, the term “nanostructure” refers to elongated chemical structures having a diameter on the order of nanometers and a length on the order of microns to millimeters, resulting in an aspect ratio greater than 10, 100, 1000, 10,000, or greater. In some cases, the nanostructure may have a diameter less than 1 μm, less than 100 nm, 50 nm, less than 25 nm, less than 10 nm, less than 5 nm, less than 2 nm, or, in some cases, less than 1 nm. In some cases, the nanostructure may have a diameter between about 1 nm to about 2 nm. Typically, the nanostructure may have a cylindrical or pseudo-cylindrical shape. In some cases, the nanostructure may be a nanotube, such as a carbon nanotube. In some cases, the nanostructure may comprise primarily carbon atoms, heteroatoms, or metal atoms. In some cases, the nanostructure may comprise a mixture of carbon atoms, heteroatoms, and/or metal atoms.

As used herein, the term “nanotube” is given its ordinary meaning in the art and refers to a substantially cylindrical molecule or nanostructure comprising a fused network of primarily six-membered aromatic rings. In some cases, nanotubes may resemble a sheet of graphite formed into a seamless cylindrical structure. It should be understood that the nanotube may also comprise rings or lattice structures other than six-membered rings. In some cases, at least one end of the nanotube may be capped, i.e., with a curved or nonplanar aromatic group. In some cases, the nanotube may lack end-caps and may be open at both ends, forming a nanotube belt. Nanotubes may have a diameter of the order of nanometers and a length on the order of millimeters, or, on the order of tenths of microns, resulting in an aspect ratio greater than 100, 1000, 10,000, or greater. In some cases, the nanotube is a carbon nanotube. The term “carbon nanotube” refers to nanotubes comprising primarily carbon atoms and includes single-walled nanotubes (SWNTs), double-walled CNTs (DWNTs), multi-walled nanotubes (MWNTs) (e.g., concentric carbon nanotubes), inorganic derivatives thereof, and the like. In some embodiments, the carbon nanotube is a single-walled carbon nanotube. In some cases, the carbon nanotube is a multi-walled carbon nanotube (e.g., a double-walled carbon nanotube). In some cases, the nanotube may have a diameter less than 1 μm, less than 100 nm, 50 nm, less than 25 nm, less than 10 nm, less than 5 nm, less than 2 nm, or, in some cases, less than 1 nm. In some cases, the nanotube may have a diameter between about 1 nm to about 2 nm.

Nanostructures, such as nanotubes, may be characterized using methods known in the art, including Raman spectroscopy.

It should be understood that formation of nanotubes is described herein by way of example only, and that other nanostructures may also be formed using methods of the invention, including nanotubes, nanowires, nanofibers, and the like. In some cases, the nanostructure may be a sheet of graphene.

In some cases, the nanostructure may be a fullerene. As used herein, the term “fullerene” is given its ordinary meaning in the art and refers to a substantially spherical molecule generally comprising a fused network of five-membered and/or six-membered aromatic rings. For example, C₆₀ is a fullerene which mimics the shape of a soccer ball. The term fullerene may also include molecules having a shape that is related to a spherical shape, such as an ellipsoid. It should be understood that the fullerene may comprise rings other than six-membered rings. In some embodiments, the fullerene may comprise seven-membered rings, or larger. Fullerenes may include C₃₆, C₅₀, C₆₀, C₇₀, C₇₆, C₈₄, and the like.

As used herein, the term “react” or “reacting” refers to the formation of a bond between two or more components to produce a stable, isolable compound. For example, a first component and a second component may react to form one reaction product comprising the first component and the second component joined by a covalent bond. The term “reacting” does not refer to the interaction of solvents, catalysts, bases, ligands, or other materials which may serve to promote the occurrence of the reaction with the component(s). A “stable, isolable compound” refers to isolated reaction products and does not refer to unstable intermediates or transition states.

As used herein, a first nanostructure may be exposed to “essentially the same set of conditions” or “essentially identical conditions” as a second nanostructure by subjecting the first and second nanostructures to a similar or substantially identical set of environmental parameters, such as temperature, pressure, pH, solvent, concentration, chemical reagent, atmosphere (e.g., nitrogen, argon, oxygen, etc.), electric field, electromagnetic radiation, other source of external energy, or the like, for a similar or identical period of time.

### EXAMPLES

As described herein, methods for nanostructure production involving the design and execution of rational chemical syntheses of nanotubes are provided. Using a template and a feedstock capable of iterative growth, the diameter and chirality of the synthesized nanotubes may be controlled. In this way, nanotubes with desirable properties, such as electrical conductivity in the case of armchair nanotubes, could be made available for many applications. A controlled synthetic approach resulting in a template capable of iterative growth to form one orientation of nanotube would constitute a revolution in the production techniques seen in industry today.

### Example 1

In order to make a nanotube of specific diamater and ring orientation, studies utilizing a template that fixes, or locks in, these variables were conducted. Such a template can form the parallel walls of a nanotube and adopt the armchair orientation of benzene rings at the rim of the tube. One such template would be an aromatic end-cap, as shown in FIG. 1A. Compound 1, which is a hemisphere-shaped species including a network of unsaturated 5- and 6-membered rings, is a template that can grow unidirectionally to form a capped nanotube. A logical synthetic approch to this kind of material would allow control of nearly every aspect of the growing nanotube (e.g., diameter, ring orientation, etc.). Another benefit provided by use of such a template is be the ability to amplify even small mass quantities of end-cap templates into nanotubes of higher mass. Several iterations of growth can add significant length and mass to a molecule. In addition, this technique is not limited to capped nanotubes. Suitable templates for growth can be designed, such as an aromatic loop or “belt,” such that similar nanotube growth may be performed. For example, an aromatic belt, as shown in FIG. 1B, could provide for growth in two directions simultaneously, and graphene sheets, as shown in FIG. 1C, could provide for growth or enlargment/elongation of aromatic ribbons using this type of iterative growth.

The basis of the method of growth comes from a dieneophile for [4+2] cycloaddition that is capable of a subsequent intramolecular elimination to yield an benzene ring. (FIG. 3A) This approach can provide increased reactivity for the cycloaddition and can leave the growing nanotube poised for subsequent addition, as shown in FIG. 3B. FIG. 3C demonstrates an aromatic bay region can be converted into a new benzene ring in a single operation using phenylvinyl sulfuoxide (PVS). This molecule, though incapable of adding to perylene, adds readily to a slightly larger polycyclic aromatic hydrocarbons, such as the modified bisanthene 5.

Bisanthene 5 was synthesized to mimic the polycyclic aromatic hydrocarbon (PAH) framework of a nanotube. Density functional therory (DFT) calculations were run to determine the transition state energy of adding acetylene to PAHs with increasing numbers of aromatic rings. A significant drop in transition state energy was observed between perylene and bisanthene, followed by a gradual leveling off of energies for bistetracene and beyond (FIG. 2). Without wishing to be bound by theory, it is believed that this bisanthene may serve as a good representation of the energetics of addition to an armchair carbon nanotube.

After each cycloaddition, the molecule may undergo loss of 2H (e.g., thermal loss, oxidative loss) and the oxygen of PVS may deprotonate the resulting bridge to cause intramolecular elmination of PhSOH, thereby imparting aromaticity to the newly formed ring. Additionally, aromaticity may be restored to other portions of the nanostructure precursor, i.e., portions where aromaticity had been interrupted upon occurrence of the cycloaddition reaction. The remaining molecule is then poised for another addition on the opposite side, resulting in ovalene (6). (FIG. 3C)

To test this method further, the reactivity of an in situ generated nitroethylene was examined. The nitro functionality was shown to increase the reactivity of the dienophile to allow mono-addition and rearomatization even on the less reactive perylene. Nitroethylene also readily converted 5 to 6. The nitroethylene version of this growth was observed, in this example, to have improved performance to that of PVS (4) due to its increased reactivity and the ease of product purification. Nitroethylene was shown to add to perylene once while PVS underwent no addition. In addition, the byproducts and remaining reagents of the nitroethylene reaction were soluble in ethanol and could be washed away from the product. This solubility may also be useful for nanotubes since increasing length quickly decreases solubility. PVS has a tendency to polymerize and remain with the product after washing.

The addition of benzyne to template 5 was also investigated. Benzyne was generated in situ by two methods. The first method is the thermal conversion of ortho-phenyldiazonium carboxylate (7) to benzyne in refluxing solvent, o-dichlorobenzene for instance. This resulted in production of a dibenzovalene (8) (FIG. 3D). The production of benzyne by the fluoride ion induced elimination of fluorotrimethylsilane and trifluoromethanesulfonate ion from 2-(trimethylsilyl)phenyl triflate proved to be ammenable to lower temperatures and a variety of solvents. When 5 was used, multiple additions beyond that of 7 were observed by mass spectrometry, due to secondary additions to the newly formed bay regions. This may show great potential for growing graphene sheets and nanotubes. After a minimum of two benzyne molecules add, a cyclodehydrogenation would occur to form two new bay regions. When a whole ring of C₆H₄ addends attach and cyclodehydrogenate they will have reformed the armchair edge of the growing tube. It is likely that conditions can be found where both addition and cyclodehydrogenation occur.

### Example 2

### Synthesis of 7,14-bis(2,4,6-trimethylphenyl)ovalene 6

To a flame dried 15 mL pressure vessel under nitrogen, 7,14-bis(2,4,6-trimethylphenyl)bisanthene was added. This was followed by 50 molar equivalents each of phthalic anhydride and 2-nitroethanol. Dry toluene was added to achieve a concentration of 0.014 mol 6/L. The vessel was sealed with a screw-top cap and placed in an oil bath at 150° C. The color changed from blue to purple and finally to burgundy within hours, but the reaction was allowed to run for 1 day. Upon cooling, the seal was broken, and the reaction mixture was concentrated to dryness under reduced pressure. The remaining solids were taken up in ethanol and filtered to leave a burgundy solid in 60-80% yield. Further purification was achieved by chromatography on a silica column with 10% dichloromethane in hexanes. The product eluted first as a yellow solution, followed by the mono-addition product as a pink-orange band.

A similar procedure was used with phenyl vinyl sulfoxide, though the reaction was run neat in reactant. Washing the filter with ethanol followed by acetone removed the majority of the PVS, though a significant amount of oligomerized material remained.

### Example 3

### Synthesis of 7,14-bis(2,4,6-trimethylphenyl)dibenz[d,o]ovalene (8) and further additions

To a flame dried 50 mL two-necked round bottom flask equipped with a reflux condenser, two rubber septa, and under nitrogen, 7,14-bis(2,4,6-trimethylphenyl)bisanthene and 20 molar equivalents of tetrabutylammonium fluoride trihydrate (TBAF) were added, followed by dry toluene to give a concentration of 0.0017 mol/L. An equal number of equivalents of 2-(trimethylsilyl)phenyl trifluoromethanesulfonate as TBAF were added dropwise via syringe at the rate of approximately 2 mL/hour at 110° C. After completion of the addition, the reaction mixture was allowed to reflux 1-2 hours. The solution was then cooled to room temperature, washed with 3×300 mL of H₂O, and concentrated to dryness under reduced pressure. The resulting solid was taken up in ethanol and filtered to yield a deep red-brown solid (52%) as well as an orange filtrate.

### Example 4

Calculations of various dienophiles capable of elimination and their relative energies to that of the addition of PVS were calculated, as shown in Table 1.

TABLE 1
Diels-Alder Transition States of Dienophiles
with Cyclopentadiene
AM1 calculations (kcal/mol)

| Dienophile | From PVS |
|---|---|
| PVS | 0.00 |
| PFPVS | −1.22 |
| TFMVS | −2.70 |
| MeOVS | −0.70 |
| TCMVS | −2.45 |
| pNPVS | −0.85 |
| IOH | 0.96 |
| IOAc | −0.69 |
| N-Et | −4.95 |
| IO— | 3.92 |
| Ethylene | −1.69 |
| Acetylene | 5.61 |

PVS phenylvinyl sulfoxide
PFPVS pentafluorophenylvinyl sulfoxide
TFMVS trifluoromethylvinyl sulfoxide
TCMVS trichloromethylvinyl sulfoxide
pNPVS p-Nitrophenylvinyl sulfoxide
IOH phenylvinyl iodoalcohol
IOAc phenylvinyl iodoacetate
N-Et nitroethylene
IO— phenylvinyl iodooxide

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed:

1. A method for synthesizing a nanostructure,
reacting a nanostructure precursor comprising a fused network of aromatic rings and a border at which the fused network terminates with a dienophile via a cycloaddition reaction to form a nanostructure product,
wherein at least 50% of the nanostructure product comprises nanostructures having essentially the same diameter and/or ring orientation, or exhibiting essentially the same electrochemical properties when placed under essentially the same set of conditions.

2. A method for synthesizing a nanostructure, comprising:
reacting a nanostructure precursor comprising a fused network of aromatic rings and a border at which the fused network terminates with a dienophile via a cycloaddition reaction to form a ring fused to the border of the nanostructure precursor.

3. A method as in claim 2, further comprising:
allowing disassociation of at least one atom, or group of atoms, associated with the ring to occur.

4. A method as in claim 1, further comprising:
repeating the act of reacting at least one time to increase the length of the nanostructure precursor.

5. A method as in claim 1, wherein the nanostructure precursor has a cycloaddition activation energy of less than 30 kcal/mol, as calculated using B3LYP/6-31G* density functional theory.

6. A method as in claim 5, wherein the nanostructure precursor has a cycloaddition activation energy of less than 25 kcal/mol, as calculated using B3LYP/6-31G* density functional theory.

7. A method as in claim 6, wherein the nanostructure precursor has a cycloaddition activation energy of less than 22 kcal/mol, as calculated using B3LYP/6-31G* density functional theory.

8. A method as in claim 1, wherein the cycloaddition is a Diels-Alder reaction.

9. A method as in claim 1, wherein the dienophile is acetylene.

10. A method as in claim 1, wherein the dienophile has the formula,
XHC═CH₂
or
XHC═CHY,
wherein:
X is an electron-withdrawing group; and
Y is an atom or group of atoms that, upon reacting with the nanostructure precursor, is capable of dissociating from the nanostructure product.

11. A method as in claim 10, wherein Y is an electron-withdrawing group.

12. A method as in claim 1, wherein the dienophile is phenylvinyl sulfoxide.

13. A method as in claim 1, wherein the dienophile is nitroethylene.

14. A method as in claim 13, wherein nitroethylene is generated in situ.

15. A method as in claim 1, wherein the dienophile comprises a benzyne species.

16. A method as in claim 15, wherein the benzyne species is generated in situ from a benzyne precursor.

17. A method as in claim 16, wherein the benzyne precursor is ortho-phenyldiazonium carboxylate or 2-(trimethylsilyl) phenyl triflate.

18. A method as in claim 2, wherein the ring fused to the border of the nanostructure precursor is a non-aromatic ring, and, upon disassociation of the at least one atom or group of atoms, the non-aromatic ring is converted to an aromatic ring.

19. A method as in claim 1, wherein at least 50% of the nanostructures have essentially the same nanotube diameter.

20. A method as in claim 1, wherein the nanostructures are nanotubes at least 50% of the nanotubes have essentially the same nanotube ring orientation.

21. A method as in claim 1, wherein at least 50% of the nanostructures exhibit essentially the same electrochemical properties when placed under essentially the same set of conditions.

22. A method as in claim 1, wherein, prior to a purification or isolation step, at least 50% of the nanostructures have essentially the same nanotube length.

23. A method as in claim 1, wherein the length of the nanostructure precursor is increased in one direction.

24. A method as in claim 1, wherein the length of the nanostructure precursor is increased in two directions.

25. A method as in claim 1, wherein the nanostructure is a nanotube, nanofiber, or nanowire.

26. A method as in claim 25, wherein the nanostructure is a nanotube.

27. A method as in claim 26, wherein the nanostructure is a carbon nanotube.

28. A method as in claim 1, wherein the nanostructure is a sheet of graphene.

29. A method as in claim 1, wherein the nanostructure precursor is a nanotube end-cap.

30. A method as in claim 1, wherein the nanostructure precursor is a substituted or unsubstituted bisanthene.

31. A method as in claim 2, wherein the aromatic ring fused to the border of the nanostructure precursor is a benzene ring.

32. A method as in claim 3, wherein the disassociation comprises thermal loss of hydrogen.

33. A method as in claim 3, wherein the disassociation comprises oxidative loss of hydrogen.

34. A method as in claim 3, wherein the disassociation comprises an intramolecular elimination reaction.

35. A method as in claim 3, wherein the disassociation comprises a cyclodehydrogenation reaction.

36. A method as in claim 1, wherein the nanostructure is a carbon nanotube.

37. A method as in claim 1, wherein the act of reacting is performed in the absence of a catalyst.

38. A method as in claim 1, wherein the act of reacting is performed at a temperature less than 1000° C.

39. A method as in claim 1, wherein the act of reacting is performed in solution.

40. A composition, comprising:
a plurality of nanostructures,
wherein at least 50% of the nanostructures have essentially the same diameter and/or ring orientation, or exhibit essentially the same electrochemical properties when placed under essentially the same set of conditions.

41. A composition as in claim 40, wherein the nanostructure is a nanotube, nanofiber, or nanowire.

42. A composition as in claim 41, wherein the nanostructure is a carbon nanotube.

43. A composition as in claim 42, wherein the carbon nanotube is an armchair nanotube.

44. A composition as in claim 42, wherein the carbon nanotube is a chiral nanotube.

45. A composition as in claim 40, wherein the nanostructure is a sheet of graphene.

46. A composition as in claim 40, wherein at least 50% of the nanostructures have essentially the same diameter and/or ring orientation, or exhibit essentially the same electrochemical properties when placed under essentially the same set of conditions.

47. A composition as in claim 46, wherein at least 60% of the nanostructures have essentially the same diameter and/or ring orientation, or exhibit essentially the same electrochemical properties when placed under essentially the same set of conditions.

48. A composition as in claim 47, wherein at least 70% of the nanostructures have essentially the same diameter and/or ring orientation, or exhibit essentially the same electrochemical properties when placed under essentially the same set of conditions.

49. A composition as in claim 48, wherein at least 80% of the nanostructures have essentially the same diameter and/or ring orientation, or exhibit essentially the same electrochemical properties when placed under essentially the same set of conditions.

50. A composition as in claim 49, wherein at least 90% of the nanostructures have essentially the same diameter and/or ring orientation, or exhibit essentially the same electrochemical properties when placed under essentially the same set of conditions.

51. A composition as in claim 50, wherein at least 95% of the nanostructures have essentially the same diameter and/or ring orientation, or exhibit essentially the same electrochemical properties when placed under essentially the same set of conditions.

52. A composition as in claim 51, wherein at least 99% of the nanostructures have essentially the same diameter and/or ring orientation, or exhibit essentially the same electrochemical properties when placed under essentially the same set of conditions.

53. A composition as in claim 52, wherein 100% of the nanostructures have essentially the same diameter and/or ring orientation, or exhibit essentially the same electrochemical properties when placed under essentially the same set of conditions.

54. A composition as in claim 40, wherein the electrochemical property is conductivity.
